(19) United States
(12) Patent Application Publication
(10) Pub. No.: US 2022/0219121 A1
(43) Pub. Date: Jul. 14, 2022

(54) MODEL PREDICTIVE CONTROL PARADIGMS FOR DIRECT CONTACT MEMBRANE DISTILLATION

(71) Applicant: KING ABDULLAH UNIVERSITY OF SCIENCE AND TECHNOLOGY, Thuwal (SA)

(72) Inventors: Taous Meriem LALEG, Thuwal (SA); Fahad Ali ALBALAWI, Thuwal (SA); Xingang GUO, Thuwal (SA)

(73) Assignee: KING ABDULLAH UNIVERSITY OF SCIENCE AND TECHNOLOGY, Thuwal (SA)

(21) Appl. No.: 17/429,655

(22) PCT Filed: Feb. 13, 2020
(86) PCT No.: PCT/IB2020/051219

§ 371 Date: Aug. 10, 2021

Related U.S. Application Data
(60) Provisional application No. 62/807,514, filed on Feb. 19, 2019.

(51) Int. Cl. B01D 61/36; G05B 13/04

(52) U.S. Cl. CPC B01D 61/366; G05B 13/048; B01D 61/364

(57) ABSTRACT

A method for controlling a direct contact membrane distillation (DCMD) system, the method including modeling the DCMD system with differential-algebraic equations (DAEs), wherein the DAEs include process states \tilde{x}(tₖ) and an input state u(tₖ); selecting a value for the input variable u(tₖ) for a time tₖ; estimating the process states \tilde{x}(tₖ) based on the DAEs and the input state u(tₖ); checking that a boundedness function G applied to the process states \tilde{x}(tₖ) is smaller than a desired steady-state point ρₑ; and minimizing an objective function, which depends on the process states \tilde{x}(tₖ) and the input state u(tₖ), to determine an updated input state u(tₖ₊₁) for a next time tₖ₊₁. The process states \tilde{x}(tₖ) include temperatures and heat flow rates.

### CROSS-REFERENCE TO RELATED APPLICATIONS

This application claims priority to U.S. Provisional Patent Application No. 62/807,514, filed on Feb. 19, 2019, entitled “OPTIMAL OPERATION OF MEMBRANE DISTILLATION PROCESSES VIA ECONOMIC MODEL PREDICTIVE CONTROL PARADIGMS,” the disclosure of which is incorporated herein by reference in its entirety.

### BACKGROUND

### Technical Field

Embodiments of the subject matter disclosed herein generally relate to a direct contact membrane distillation system, and more particularly, to a differential algebraic equations based model for predictive control of such system.

### Discussion of the Background

While water resources such as groundwater, rivers, lakes, and reservoirs are rapidly being exhausted, more attention is drawn to the desalination of seawater and brackish water concentrations, which are readily available in large quantities. The estimated cost of water desalination varies from one technology to another due to many factors. Among these factors are the desalination method, the level of feed water salinity, the capacity of the desalination plant, and the energy source. The primary element that heavily contributes to this cost is the type of energy used to desalinate the seawater. Conventional desalination techniques are very costly both in terms of environmental and financial terms.

Researchers and technology developers have investigated the potential of using renewable energy sources to develop efficient and sustainable desalination plants. To achieve a sustainable desalination process, a Membrane Distillation (MD) process, which is a thermally driven desalination process that can be operated with low solar thermal energy, has been developed. Several configurations have been proposed for the MD configuration: the Direct Contact Membrane Distillation (DCMD) and the Air Gap Membrane Distillation (AGMD).

However, the primary drawback that still prevents the MD technology from becoming commercially available is the low water production rate. To operate MD optimally, one needs to develop an appropriate control strategy that can maximize the water production rate while taking various process constraints into account.

Following this direction, several contributions have been made to optimize the MD process in terms of thermal efficiency and distillate water production. For example, a proportional integral (PI) controller and on/off controllers were proposed for the AGMD to track optimal operation trajectories. The optimal operation trajectories are calculated off-line and tend to maximize the distilled water flux. Another optimization-based technique, termed non-dominated sorting genetic algorithm II, was developed for AGMD so that the distillate flux and the thermal efficiency are maximized. In another study, a Monte-Carlo stochastic methodology was developed in order to maximize the thermal efficiency of the AGMD process.

However, in none of the aforementioned control strategies, the variability of the solar thermal energy was considered. To account for the variations that the solar thermal energy is introducing into the MD system during operation, real-time optimization techniques can be used to impose variability constraints. For instance, in one approach, a feed-forward control system that utilizes a neural network model was developed for a solar-powered membrane distillation plant. Then, an optimizing feed-forward control scheme was used to maximize the water production while taking the variability of the solar energy into account. Recently, model-free controllers named Extremum-Seeking controllers were proposed to effectively operate DCMD processes [1,2].

From a process control perspective, model-based control techniques, which utilize a model of the system to compute optimal control actions, are well-suited for complex nonlinear processes. Therefore, a two-layer model-based control architecture was developed in [3] to operate a DCMD system. In the upper layer, a Model Predictive Control (MPC) strategy calculates an offline temperature and flow-rate set points, and then proportional-integral and feed-forward controllers are implemented in the lower layer to track these set points. However, the proposed MPC scheme optimizes the set-points based on a stage cost that reflects the solar energy use without taking inputs and process operational constraints into account.

Another MPC strategy was proposed in [4] for a distributed collector field of a solar desalination plant. The proposed MPC scheme manipulated the water flow rate to keep the temperature gradient value in the collectors constant. The MPC scheme developed in [4] only considers the input limitations when calculating the optimal control solution, and ignores other process operational constraints such as stability and solar thermal variability-based constraints.

However, the model predictive controllers can be regarded as steady-state operation control strategies that rely on the off-line calculation for the optimal operating points. Such a steady-state operation control technique may degrade the performance of the MD systems due to the variability of the solar thermal energy.

Alternatively, a form of MPC, termed Economic Model Predict Control (EMPC) can dictate real-time dynamic economic optimization while meeting input constraints and other process constraints such as safety and stability constraints. Although EMPC schemes for ordinary differential equations (ODEs) were extensively studied in the control field, a small number of EMPC schemes were developed for differential-algebraic equations (DAEs) [5]. To date, there is limited work on formulating an EMPC or MPC paradigm that can operate the DCMC process in a time-varying fashion while meeting inputs and process operation constraints.

Thus, there is a need for a novel MPC model for DCMD systems that maximizes water production and takes into consideration various process constraints, and also avoids the limitations of the models discussed above.

### BRIEF SUMMARY OF THE INVENTION

According to an embodiment, there is a method for controlling a direct contact membrane distillation (DCMD) system. The method includes modeling the DCMD system with differential-algebraic equations (DAEs), wherein the DAEs include process states \tilde{x}(tₖ) and an input state u(tₖ); selecting a value for the input variable u(tₖ) for a time tₖ; estimating the process states \tilde{x}(tₖ) based on the DAEs and the input state u(tₖ); checking that a boundedness function G applied to the process states \tilde{x}(tₖ) is smaller than a desired steady-state point ρₑ, and minimizing an objective function, which depends on the process states \tilde{x}(tₖ) and the input state u(tₖ), to determine an updated input state u(tₖ₊₁) for a next time tₖ₊₁. The process states \tilde{x}(tₖ) include temperatures and heat flow rates.

According to another embodiment, there is a method for controlling a direct contact membrane distillation (DCMD) system, and the method includes modeling the DCMD system with differential-algebraic equations (DAEs), wherein the DAEs include process states \tilde{x}(tₖ) and an input state u(tₖ); selecting a value for the input variable u(tₖ) for a time tₖ; estimating the process states \tilde{x}(tₖ) based on the DAEs and the input state u(tₖ); checking that a boundedness function G applied to the process states \tilde{x}(tₖ) is smaller than a desired steady-state point ρₑ; and minimizing an objective function, which depends on a distilled water flux J and a slack variable δ(tₖ), to determine an updated input state u(tₖ₊₁) for a next time tₖ₊₁. The process states \tilde{x}(tₖ) include temperatures and heat flow rates.

According to yet another embodiment, there is a direct contact membrane distillation (DCMD) system that includes a distillation membrane, a feed part in contact with the distillation membrane, the feed part configured to receive a feed, a permeate part in contact with the distillation membrane, the permeate part configured to receive a permeate, and a controller configured to control a flow of the feed. The controller is configured to model the DCMD system with differential-algebraic equations (DAEs), wherein the DAEs include process states \tilde{x}(tₖ) and an input state u(tₖ); select a value for the input variable u(tₖ) for a time tₖ; estimate the process states \tilde{x}(tₖ) based on the DAEs and the input state u(tₖ); check that a boundedness function G applied to the process states \tilde{x}(tₖ) is smaller than a desired steady-state point ρₑ, and minimize an objective function to determine an updated input state u(tₖ₊₁) for a next time tₖ₊₁. The objective function depends on a distilled water flux J and a slack variable δ(tₖ) or the objective function depends on the process states \tilde{x}(tₖ) and the input state u(tₖ).

### BRIEF DESCRIPTION OF THE DRAWINGS

For a more complete understanding of the present invention, reference is now made to the following descriptions taken in conjunction with the accompanying drawings, in which:

FIG. 1 is a schematic diagram of a distillation membrane module;

FIG. 2 is a schematic diagram of a cell of a distillation membrane module;

FIG. 3 illustrates the dimensions of the various matrices that form the differential-algebraic equations that describe the distillation module;

FIG. 4 is a flowchart of a method for controlling the distillation module based on a steady-state;

FIG. 5 illustrates a direct contact membrane distillation system that is controlled with the method of FIG. 4;

FIG. 6 is a flowchart of another method for controlling the direct contact membrane distillation system;

FIG. 7 illustrates the various parameters that are used by the control methods;

FIGS. 8 and 9 illustrate the process states while FIG. 10 illustrates the input state for the first control method;

FIGS. 11 and 12 illustrate the process states while FIG. 13 illustrates the input state for the second control method;

FIG. 14 illustrates a membrane temperature difference between the feed and permeate sides when the second control method is applied;

FIG. 15 compares the distilled water production of the distillation system when controlled with the first and second control methods;

FIG. 16 schematically illustrates a structure of a control system that is configured to implement the first or second methods;

FIG. 17 is a flowchart of a method for controlling the distillation system; and

FIG. 18 is a flowchart of another method for controlling the distillation system.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a distillation system that uses a direct membrane contact distillation process. However, the embodiments to be discussed next are not limited to such a system or process, but they may be applied to other systems or distillation processes.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to the following embodiments, two MPC schemes that can maximize the water production rate of DCMD modules are discussed herein. The first MPC scheme is formulated to track an optimal set-point while taking input and stability constraints into account. The second MPC scheme, termed Economic Model Predictive Control (EMPC), is formulated to maximize the distilled water flux while meeting input, stability and other process operational constraints. The proposed MPC methods aim to maximize the production rate of the distilled water. Stability constraints and other operational constraints such as input constraints and temperature gradient-based constraints were incorporated into the MPC designs. To illustrate the effectiveness of the two proposed control paradigms, the total water production under both control designs is investigated.

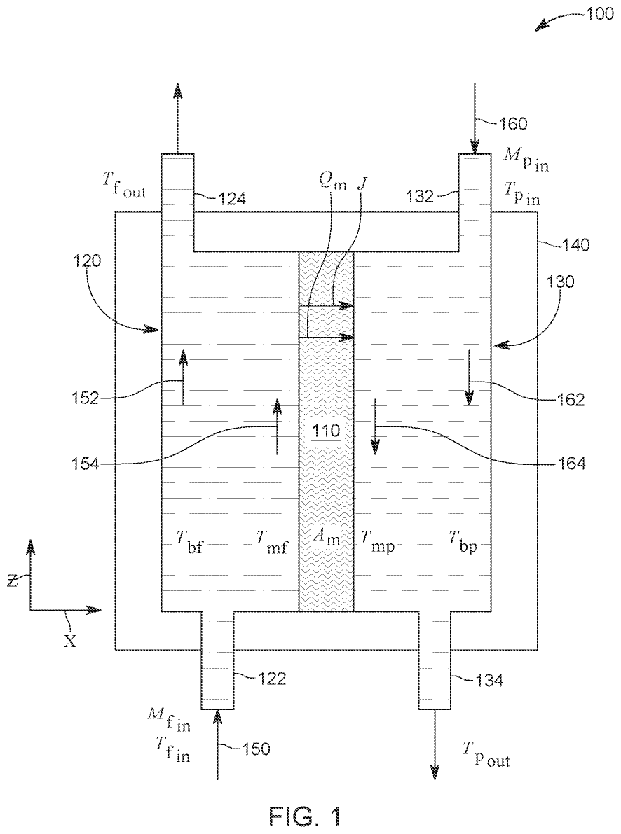

Before discussing these two novel methods, a mathematical description of the DCMD module is presented. The DCMD module implements an MD process by having a hot feed side and a cold permeate side separated by a hydrophobic membrane. A schematic diagram of the DCMD module 100 is shown in FIG. 1. The DCMD module 100 includes, at a minimum, a membrane 110, a feed part 120, and a permeate part 130. The membrane 110, most of the feed part 120, and most of the permeate part 130 are placed in a housing 140. The feed part 120 has a feed inlet 122 for receiving the feed 150, and a feed outlet 124 for discharging the feed 150. Similarly, the permeate part 130 has a permeate inlet 132 for receiving the permeate 160 and a permeate outlet 134 for discharging the permeate.

Note that the feed 150, after entering the feed part 120, can be described as having a hotter bulk stream 152 and a colder membrane interface stream 154. Similarly, the permeate 160, after entering the permeate part 130, can be described as having a colder bulk stream 162 and a hotter membrane interface stream 164. The temperature of each of these streams is illustrated in FIG. 1. FIG. 1 also illustrates the in and out temperatures of the feed and permeate and feed-in mass and the permeate-in mass. The letters characterizing the temperatures and the masses in the figure are used as follows: letter “f” stands for feed, letter “p” for permeate, letter “b” for bulk, and letter “m” for membrane. FIG. 1 also shows the heat flux Qm of the water vapors from the feed part to the permeate part, and the mass flux J associated with the water vapors passing from the feed part to the permeate part.

In this process, the heat and mass transfers occur simultaneously. The feed vapor is transported through the hydrophobic membrane 110 to the permeate part 130 due to the vapor pressure difference between the two sides of the membrane pores. Then, the water vapor condenses in the permeate side. Since only water vapor is allowed through the hydrophobic membrane 110, the DMCD process has a 100% rejection rate of ions. A 2D Advection-Diffusion Equation was utilized in the past to describe the heat and mass transfer mechanisms that take place inside the DCMD module. A partial differential equation (PDE)-based model for describing the DCMD process is known. However, the PDE-based models pose computational challenges when they are used in model-based control designs.

Alternatively, a nonlinear DAE-based model [6] can be used for the DCMD module. The DAE-based model is more suitable for model-based control designs because it is a reduced-order version of an equivalent PDE model. This model reduction can help decrease the overall computation cost of the model-based control design. Thus, the embodiments discussed herein considers the DAE-based model proposed in [6], which is briefly discussed now.

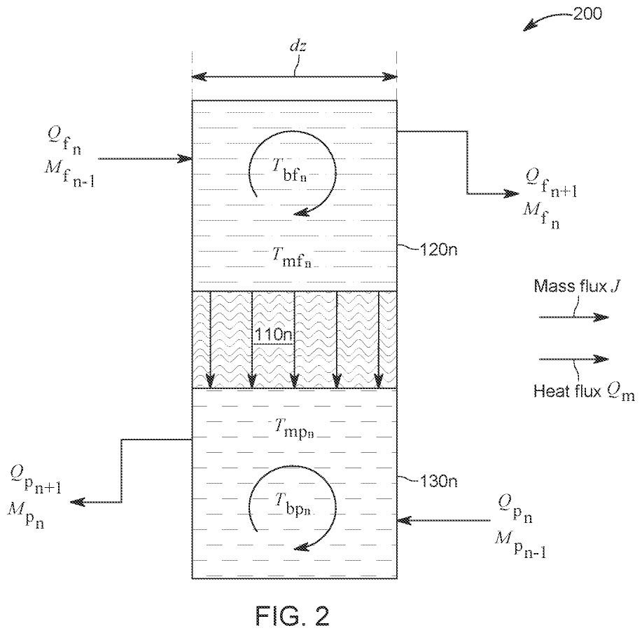

To consider spatial variations on the temperature along the feed and permeate flow directions, the DCMD module is divided into a series of n control-volume cells, one of these cells 200 being illustrated in FIG. 2. A control-volume cell 200 includes a small part 120n of the feed part 120, a small part 110n of the membrane 110, and a small part 130n of the permeate part 130. In one embodiment, the number of cells n is between 1 and 100. A size of the cell is considered to be dz and it can be selected to be as small as desired. Each part is characterized by the mass that enters the cell and the mass that exits the cell at the feed and permeate parts, and the corresponding heats.

An analogous electrical thermal network for each cell is constructed and its elements are parameterized. Based on the lumped capacitance method, a dynamical DAE-based model for the DCMD is derived as follows [6], [7]:

E\dot{x}(t)=F(x(t))x(t)+Bu(t) (1)

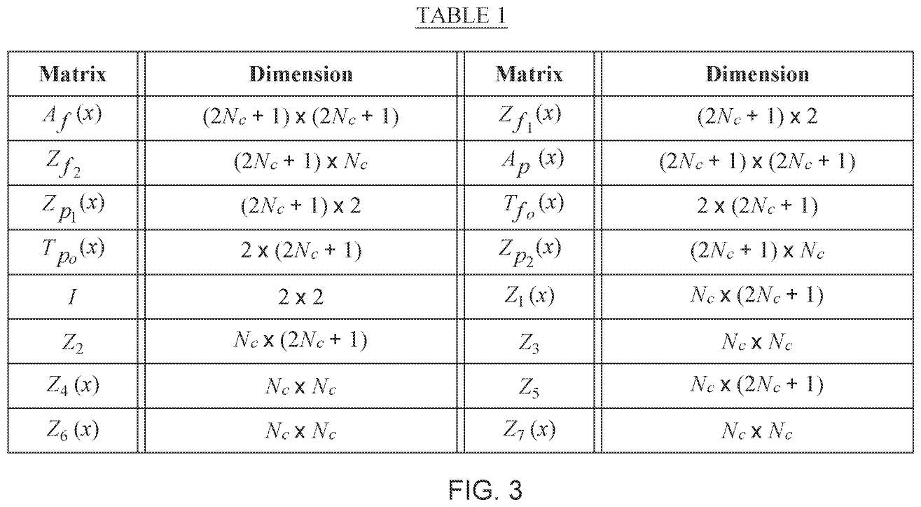

y=Cx(t) (1)

where the input variable u(t), matrices E, B and C, and function F are introduced later. Vector x(t)∈R^{6N}^{_{c}}⁺⁴ includes both differential states and algebraic states in the following order:

$$x ( t ) = [ {Q}_{{f}_{1}} , {T}_{{bf}_{1}} , … {Q}_{{f}_{{N}_{c}}} , {T}_{{bf}_{{N}_{c}}} , {Q}_{{f}_{{N}_{c} + 1}} , {T}_{{bN}_{c}} , {Q}_{{p}_{1}} , {T}_{{bp}_{1}} , … , {Q}_{{p}_{{N}_{c}}} , {T}_{{bp}_{{N}_{c}}} , {Q}_{{p}_{{N}_{c} + 1}} , {T}_{{f}_{out}} , {T}_{{p}_{out}} , {T}_{{mf}_{1}} , … , {T}_{{mf}_{{N}_{c}}} , {T}_{{mp}_{1}} , … , {T}_{{m p}_{{N}_{c}}} ] , \qquad ( 2 )$$

where N_{c} is the number of control-volume cells chosen to model the system, Q_{f}_{ₙ} and Q_{f}_{ₙ₊₁} is the heat transfer rate into and out of the n^{th} feed cell 120n, respectively, Qₚ_{ₙ} and Qₚ_{ₙ₊₁} are the heat transfer rate into and out of the n^{th} permeate cell 130n, respectively, and T_{bf}_{ₙ} and T_{bp}_{ₙ} are the bulk temperatures in the feed part and the permeate park, respectively, which are uniform through the cell except at the membrane interface due to the temperature polarization effect. The outlet temperature of the feed side and permeate side are denoted by T_{f}_{ₒᵤₜ}T and Tₚ_{ₒᵤₜ}, respectively. T_{mf}_{ₙ} and Tₘₚ_{ₙ} represent the feed side and permeate side interface temperature of the n^{th} cell, respectively. In equation (1), y is the output and may include the permeate and feed output temperatures. The matrix F(x(t))∈R^{6N}^{_{c}}^{+4×6N}^{_{c}}⁺⁴ represents the non-linear dynamics of equation (1), and it is composed of several block matrices. These block matrices account for the dynamics of the feed and permeate sides of the DCMD model. The non-linear function F(x(t)) is defined as follows:

$$F ( x ( t ) ) = [ \begin{matrix}{A}_{f} ( x ) & 0 & {Z}_{{f}_{1}} ( x ) & {Z}_{{f}_{2}} & 0 \\ 0 & {A}_{p} ( x ) & {Z}_{{p}_{1}} ( x ) & 0 & {Z}_{{p}_{2}} ( x ) \\ {T}_{{f}_{0}} ( x ) & {T}_{{p}_{0}} ( x ) & I & 0 & 0 \\ {Z}_{1} ( x ) & {Z}_{2} & 0 & {Z}_{3} & {Z}_{4} ( x ) \\ 0 & {Z}_{5} & 0 & {Z}_{6} ( x ) & {Z}_{7} ( x )\end{matrix} ] , \qquad ( 3 )$$

where the dimensions of the matrix blocks are shown in Table 1, in FIG. 3.

The matrix E in equation (1) is singular, and it is structured as follows:

$$E = [ \begin{matrix}{I}_{4 {N}_{c} + 2 \times 4 {N}_{c} + 2} & 0 \\ 0 & {0}_{2 {N}_{c} + 2 \times 2 {N}_{c} + 2}\end{matrix} ] , \qquad ( 4 )$$

where I is the identity matrix and 0 is the zero matrix of the appropriate size.

The transfer input states matrix B in equation (1) belongs to space R^{6N}^{_{c}}^{+4×1} and represents the input channel to the system, which is given as follows:

B=[8αM_{f}_{ᵢₙ}⁴,0 . . . 0]^{T}, (5)

where α and M_{f}_{ᵢₙ} are constants. M_{f}_{ᵢₙ} and Mₚ_{ᵢₙ}, which are illustrated in FIG. 1, refer to the mass flow rate coming into the first cell in the feed side and permeate side, respectively.

The input variable u(t) of the DAE of equation (1) is chosen in this embodiment to be the feed inlet temperature T_{f}_{ᵢₙ}. For simplicity, the permeate inlet temperature Tₚ_{ᵢₙ} is set as a constant. The output y of the system is the feed outlet temperature and the permeate outlet temperature.

The observation matrix C∈R^{2×6N}^{_{c}}⁺⁴ is given as follows:

C=[0_{2×4N}_{_{c}}₊₂I_{2×2}0_{2×2N}_{_{c}}]. (6)

The DCMD process described by equation (1) is operated around an open-loop, stable, steady-state point, which corresponds to a feed inlet temperature that is equal to 50° C., i.e., 0=f (xₛₛ, uₛₛ), where uₛₛ=50° C. and xₛₛ=0, which is based on experience. This model captures the spatial and temporal responses of the temperature distribution along the flow direction. Also, the model is able to accurately predict the distilled water flux output based on various experimental validation known in the art [6], [7].

With the DAE system described above, a differentiation index of such system is now introduced as follows. The differentiation index of the DAEs is defined as the minimum number of times one has to differentiate the DAEs to get an ODEs. In other words, the differentiation index represents how far the DAE system is from the ODE system. The index is an important indicator that qualitatively measures the complexity of solving DAEs. DAEs with differentiation index one are much easier to solve than the ones with a higher index.

The index of the DCMD module described by equation (1) is now evaluated. For the DCMD module 100, equation (1) can be written as follows:

$$[ \begin{matrix}\tilde{E} \\ 0\end{matrix} ] \dot{x} ( t ) = [ \begin{matrix}{F}_{d} ( x ) \\ {F}_{a} ( x )\end{matrix} ] x ( t ) + [ \begin{matrix}{B}_{d} \\ {B}_{a}\end{matrix} ] u ( t ) , \qquad ( 7 )$$

where \tilde{E} is a full row rank matrix, F_{d}(x) and Fₐ(x) are the first 4N_{c}+2 rows and last 2N_{c}+2 rows of F(x(t)), respectively, B_{d} is a vector with the first 4N_{c}+2 elements of matrix B from equation (5), and Bₐ contains the remaining part of matrix B. After taking the derivative of the algebraic part of equation (7) with respect to time, i.e., 0=Fₐ(x)x(t)+Bₐu(t), the following system is obtained:

$$[ \begin{matrix}\tilde{E} \\ - {F}_{a} ( x )\end{matrix} ] \dot{x} ( t ) = [ \begin{matrix}{F}_{d} ( x ) \\ {\dot{F}}_{a} ( x )\end{matrix} ] x ( t ) + [ \begin{matrix}{\tilde{B}}_{d} \\ 0\end{matrix} ] u ( t ) + [ \begin{matrix}0 \\ {\tilde{B}}_{a}\end{matrix} ] \dot{u} ( t ) . \qquad ( 8 )$$

The matrix [\tilde{E}−Fₐ(x)]^{T} may or may not be singular. If this matrix is nonsingular, then the DAEs system of equation (1) is of index one. However, if the matrix [\tilde{E}−Fₐ(x)]^{T} is singular, then the procedure can be repeated until the non-singularity is reached. The number of times the algebraic equations need to be differentiated so that the matrix becomes nonsingular will be the index of the DAEs. For the DCMD module 100, the matrix [\tilde{E}−Fₐ(x)]^{T} can be written as:

$$[ \begin{matrix}\tilde{E} \\ - {F}_{a} ( x )\end{matrix} ] ∼ = [ \begin{matrix}I & 0 & 0 & 0 & 0 \\ 0 & I & 0 & 0 & 0 \\ {T}_{{f}_{0} ( x )} & {T}_{{p}_{0} ( x )} & I & 0 & 0 \\ - {Z}_{1} ( x ) & - {Z}_{2} & 0 & - {Z}_{3} & - {Z}_{4} ( x ) \\ 0 & - {Z}_{5} & 0 & - {Z}^{6} ( x ) & - {Z}_{7} ( x )\end{matrix} ] . \qquad ( 9 )$$

The first 4N_{c}+4 rows of the matrix [\tilde{E}−Fₐ(x)]^{T} are full row rank because of the upper triangle structure. In the last 2N_{c} rows, if the submatrix S consisting of −Z3, −Z4, −Z6 and −Z7 in equation (9) is a full row rank, then the whole rectangular matrix is full row rank. From [6], it is known that Z3, Z4, Z6 and Z7 are all diagonal matrices with a size N_{c}×N_{c}. Assuming that matrix Z₃=diag(a), Z₄=diag(b(x)), Z₆=diag(c(x)), and Z₇=diag(d(x)), then the matrix S can be written as:

$$S = [ \begin{matrix}- a & & & - b ( x ) & & \\ & ⋱ & & & ⋱ & \\ & & - a & & & - b ( x ) \\ - c ( x ) & & & - d ( x ) & & \\ & ⋱ & & & ⋱ & \\ & & - c ( x ) & & & - d ( x )\end{matrix} ] . \qquad ( 10 )$$

After applying the row elimination to eliminate −b(x) in the matrix in equation (10), the following upper triangle structure is obtained:

$$\tilde{S} = [ \begin{matrix}- e ( x ) & & & 0 & & \\ & ⋱ & & & ⋱ & \\ & & - e ( x ) & & & 0 \\ - c ( x ) & & & - d ( x ) & & \\ & ⋱ & & & ⋱ & \\ & & - c ( x ) & & & - d ( x )\end{matrix} ] , \qquad ( 11 )$$

where −e(x)=a−b(x)c(x)/d(x). The condition for matrix S to be full rank is:

ad(x)≠b(x)c(x), where d(x)≠0. (12)

Based on [7], it is known that d(x)>0, ad(x)<0, and b(x)c(x)>0 for all x∈R^{6N}^{_{c}}⁺⁴. This indicates that the DAE system described by equation (1) is of index one. A DAE system of index one can be integrated by known software procedures, for example, the built-in Matlab's DAE solver ode15s, and thus, this solver will be used to later simulate the DCMD module 100.

Based on the above equations, two novel model predictive control schemes for the DCMD module are now introduced. The first scheme, an MPC scheme, operates the DCMD module around an optimal steady-state point. Unlike the MPC scheme, the second scheme proposes an EMPC paradigm that operates the DCMD module in a time-varying fashion. Both MPC paradigms account for the input and process operational constraints. These two schemes are now discussed in this order.

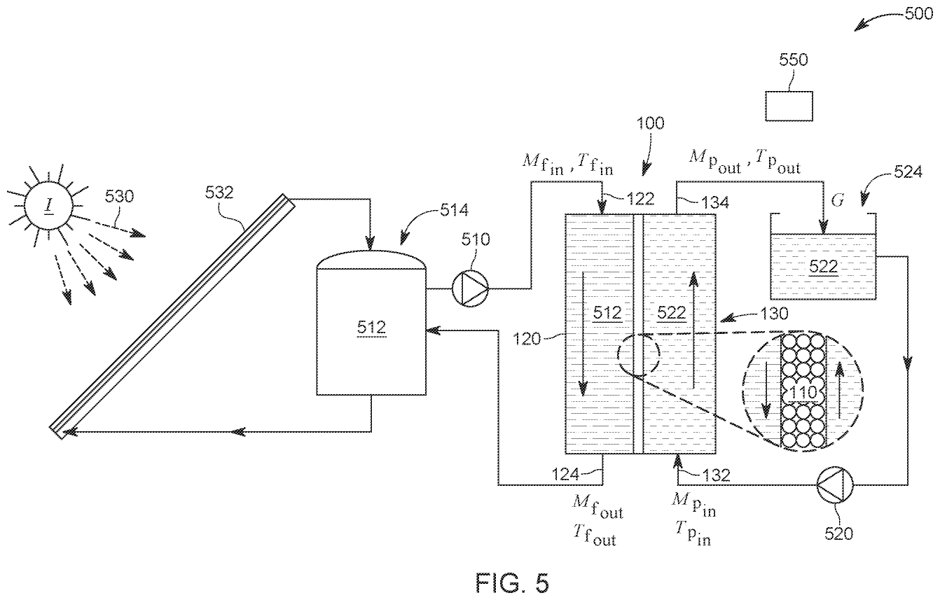

A traditional MPC scheme is an optimization-based control methodology mostly adopted in chemical and petrochemical industry. The control objective of the MPC scheme is to steer the closed-loop system to a steady-state point while meeting process and input constraints. This is achieved by minimizing a quadratic function that penalizes the deviation of the process states (e.g., membrane temperature in the cell shown in FIG. 2, bulk temperature also shown in FIG. 2, and the various heat flow rates also shown in FIG. 2) and inputs (e.g., feed input temperature and/or permeate input temperature, and/or feed/permeate mass rate flowing in the feed and permeate sides) from their corresponding set-points (xₛₛ, uₛₛ). In this embodiment, the following optimization problem is solved to drive the process states and inputs to an optimal set-point:

$$\begin{matrix}{min}_{u ( t ) ∈ S ( Δ )} {\int }_{{t}_{k}}^{{t}_{k + N}} [ {( \tilde{x} ( τ ) - {x}_{s s} )}^{T} W ( \tilde{x} ( τ ) - {x}_{s s} ) + {( u ( τ ) - {u}_{s s} )}^{T} R ( u ( τ ) - {u}_{s s} ) ] d τ & ( 13 a ) \\ s . t . E \dot{\tilde{x}} ( t ) = F ( \tilde{x} ( t ) ) \tilde{x} ( t ) + B u ( t ) & ( 13 b ) \\ u ( t ) ∈ U , ∀ t ∈ [ {t}_{k} , {t}_{k + N} ) & ( 13 c ) \\ \tilde{x} ( {t}_{k} ) = x ( {t}_{k} ) & ( 13 d ) \\ G ( \tilde{x} ( t ) ) \leq {ρ}_{e} , ∀ t ∈ [ {t}_{k} , {t}_{k + N} ) & ( 13 e ) \\ \vert u ( {t}_{p - 1} ) - u ( {t}_{p} ) \vert \leq 3 , ∀ p ∈ [ k + 1 , K + N ) , & ( 13 f )\end{matrix}$$

where u(t) denotes the manipulated input trajectory (the feed inlet temperature in this embodiment, but it also can be the feed inlet mass flow rate M_{f}_{ᵢₙ}) over the prediction horizon N. The family of piecewise constant functions is represented by S(Δ). Due to the physical constraints on the pumps of a MD system (to be discussed later with regard to FIG. 5), the manipulated input is restricted to be in a convex set U over the prediction horizon NΔ (see equation (13c)). In this embodiment, the input u(t) of the system is constrained to the following set U={u(t)⊂S(Δ)|25° C.≤u≤65° C.}. The sampling period of the MPC is denoted by Δ, and the current sampling time is denoted by tₖ. Only the first control action u(tₖ) of the MPC described by equations (13a) to (13f) is implemented, and then the MPC horizon is rolled again over the next time step. Throughout the sampling period (i.e., tₖ→tₖ₊₁), the first control action is applied in a sampled-and-hold fashion. Equation (13a) represents the quadratic objective function of the MPC method, where the weighting matrices W and R are positive definite matrices and they are chosen to account for the different order of magnitude of the process states and inputs.

For the DCMD module described by equation (1), the weight that corresponds to heat transfer rate states is set to be equal to 0.01, and 1 for the temperature states. At the beginning of each sampling time tₖ, the DAEs described by equation (13b) is solved to predict the DCMD process state over the entire prediction horizon NA, where the predicted states are denoted as \tilde{x}(t). The initial condition of equation (13b) is obtained from the state measurement at tₖ (see equation (13d)). The optimal steady-state that the DCMD module is operating at is a stable one. Hence, it is possible to enforce a boundedness constraint that can keep the closed-loop state within a region around such point ρₑ as defined by equation (13e). The value of the steady-state point ρₑ may be determined experimentally. In one application, the boundedness function is defined as G(\tilde{x})=(\tilde{x}−xₛₛ)^{T}E^{T}P(\tilde{x}−xₛₛ), where P is a positive definite matrix such that E^{T}P≥0. In this embodiment, the P is chosen the same as weight matrix W, and E is the singular matrix as shown in equation (4). Finally, a smoothness constraint, as defined in equation (13f), is introduced to restrict the difference between two consecutive control actions, so that they are not greater than 3° C. Other values may be used.

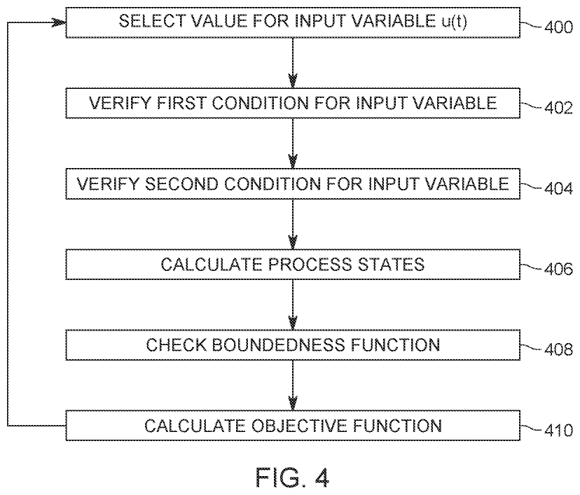

A method for applying this scheme to an MD system is now discussed with regard to FIG. 4 and the MD system is shown in FIG. 5. The MD system 500 includes, in addition to the DCMD module 100, a feed pump 510 that pumps the feed 512, from a feed tank 514 to the DCMD module 100. Further, the MD system 500 may include a permeate pump 520 that pumps the permeate 522 (e.g., freshwater), from the DCMD module 100 to a fresh water tank 524. The feed 512 in the feed tank 514 may be heated by any heat or power source. In one embodiment, it is possible to use solar energy 530, which is converted by a solar converter 532 (for example, a solar cell) into heat to heat the feed 512. The MD system 500 also has a control system 550 that is configured to implement in software various methods discussed herein and to control the water separation process based on these methods. One possible implementation of such a control system is discussed later.

The method illustrated in FIG. 4 starts in step 400 by selecting a value for the input variable u(t), which in this case is the feed inlet temperature. As noted above, the input variable u(t) can also be the feed inlet mass rate. In step 402, a first condition (equation (13c)) is verified to make sure that the value of the feed inlet temperature is within the given interval U. In step 404, a second condition (equation (13f)) is verified to ensure that the input variable u(tₖ) at current time tₖ, is within a given threshold (for example, 3° C.) from a previous value u(tₖ₋₁) of the input variable, at time tₖ₋₁. In step 406, the selected input variable u(tₖ) is used to calculate the process states \tilde{x}(tₖ) at the current time tₖ, based on equation (13b), using equation (13d) for calculating the initial values of the process states \tilde{x}(tₖ). In step 408, a boundedness function, as described by equation (13e) is verified to ensure that the system remains around the desired steady-state point ρₑ. In step 410, the method calculates the objective function described by equation (13a) and determines a new input variable u(tₖ₊₁). This value is used to repeat all the steps discussed above so that the system is maintained around the steady-state point ρₑ.

According to another embodiment, an economic model predictive control (EMPC) scheme is now discussed. Unlike the MPC design of equations (13a) to (13f), the EMPC scheme maximizes a stage cost function that reflects the process economics in a time-varying fashion (i.e., no steady-state value needed to be reached). For the DCMD process of equation (1), in this embodiment, the stage cost function is the distilled water production rate. Therefore, the control objective of the proposed EMPC scheme is to maximize the distilled water flux while meeting the existing process and input constraints. In order to achieve this, the following optimization problem is solved at every sampling time:

$$\begin{matrix}{min}_{u ( t ) , δ ( t ) ∈ S ( Δ )} {\int }_{{t}_{k}}^{{t}_{k + N}} [ {J}_{e} ( \tilde{x} ( τ ) , u ( τ ) ) - ω {‖ δ ( τ ) ‖}^{2} ] d τ & ( 14 a ) \\ s . t . E \tilde{x} ( t ) = F ( \tilde{x} ( t ) ) \tilde{x} ( t ) + B u ( t ) & ( 14 b ) \\ u ( t ) ∈ U , ∀ t ∈ [ {t}_{k} , {t}_{k + N} ) & ( 14 c ) \\ δ ( t ) \geq 0 , ∀ t ∈ [ {t}_{k} , {t}_{k + N} ) & ( 14 d ) \\ \tilde{x} ( {t}_{k} ) = x ( {t}_{k} ) & ( 14 e ) \\ G ( \tilde{x} ( t ) ) \leq {ρ}_{e} , ∀ t ∈ [ {t}_{k} , {t}_{k + N} ) & ( 14 f ) \\ \vert u ( {t}_{p - 1} ) - u ( {t}_{p} ) \vert \leq 3 , ∀ p ∈ [ k + 1 , K + N ) , & ( 14 g ) \\ \vert Δ T ( t ) \vert = {T}_{o p t} + δ ( t ) , ∀ t ∈ [ {t}_{k} , {t}_{k + N} ) \\ {T}_{o p t} = 25 if {t}_{k} < \frac{{t}_{f}}{2} \\ {T}_{o p t} = 17 if {t}_{k} \geq \frac{{t}_{f}}{2} . & ( 14 h )\end{matrix}$$

In this formulation, in addition to the input decision variable u(t), another decision variable, called herein the slack variable δ(t)≥0 is optimized within the EMPC formulation of equation (14a). The objective function of the EMPC scheme illustrated in equation (14a) includes two terms. The first term Jₑ(\tilde{x}(τ), u(τ)) represents the economic cost function which is the distilled water flux. The second term includes a penalization term of the slack variable δ(t). A tuning parameter that adjusts the tradeoff between the two terms in equation (14a) is denoted by ω. The term ΔT(t) defines the temperature difference between the feed side and permeate side along the membrane. To achieve optimal distillation performance, the value of the term ΔT(t) should be kept constant along the membrane. Because the permeate inlet temperature is constant, only the inlet feed temperature variable u(t) can change the value of ΔT(t). Therefore, imposing any constraint on the term ΔT(t) will directly impose limitations on the inlet feed temperature u(t).

The slack variable δ(t) is utilized to relax the hard constraint imposed by equation (14h) on the term ΔT(t). Due to the discrepancy of the solar thermal energy between two consecutive hours, the value of ΔT(t) is restricted to be equal to 25° C. for the first half of the operating period and 17° C. for the remaining period of operation, as noted in equation (14h). Other values may be selected for these temperatures or more temperature intervals may be used. By setting these values in equation (14h), one can see the flexibility of the EMPC scheme as there is no specific operating point to target, and thus, the process can be operated in a time-varying fashion to optimize the process economics based on a more general economic cost and other economically oriented constraints. The remaining constraints and notations are similar to that of equations (13a) to (13f).

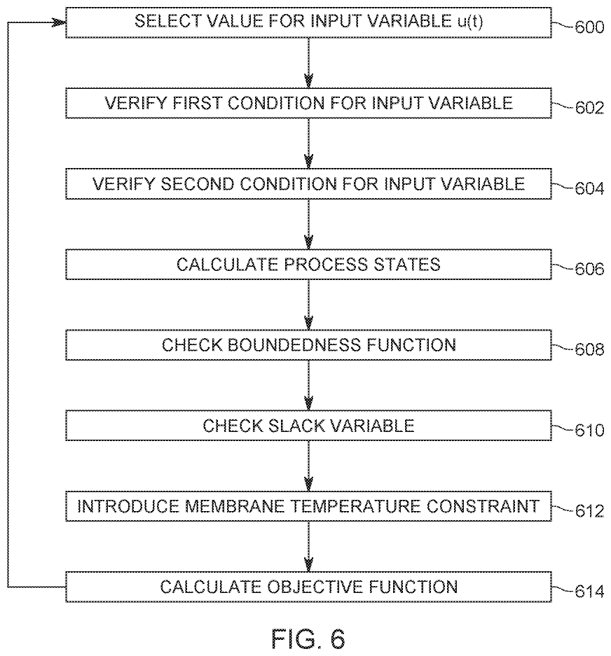

This scheme may be implemented in the system 500 discussed above as now discussed. In step 600, in FIG. 6, a value is selected for the input variable u(t), which in this case is the feed inlet temperature. However, in another embodiment, the input variable u(t) may be selected to be another characteristic of the system. In step 602, a first condition (equation (14c)) is verified to make sure that the value of the feed inlet temperature is within the given interval U. In step 604, a second condition (equation (14g)) is verified to ensure that the input variable u(tₖ) at current tₖ, is within a given threshold (for example, 3° C.) from the previous value u(tₖ₋₁) of the input variable, at time tₖ₋₁. In step 606, the selected input variable u(tₖ) is used to calculate the process states \tilde{x}(tₖ) at the current time tₖ, based on equation (14b), and using equation (14e) for calculating the initial values of the process states \tilde{x}(tₖ). In step 608, a boundedness function, as described by equation (14f) is verified to ensure that the system remains around the desired steady-state point ρₑ. In step 610, a slack variable may be checked to be larger than zero, based on equation (14d), and in step 612, a constrain is introduced for the membrane temperature difference between the feed and permeate sides, based on equation (14h). Then, in step 614, the method calculates the objective function described by equation (14a) and determines a new input variable u(tₖ₊₁) and a new slack variable δ(tₖ₊₁). These values are used to repeat all the steps discussed above so that the system maximizes the distilled water flux.

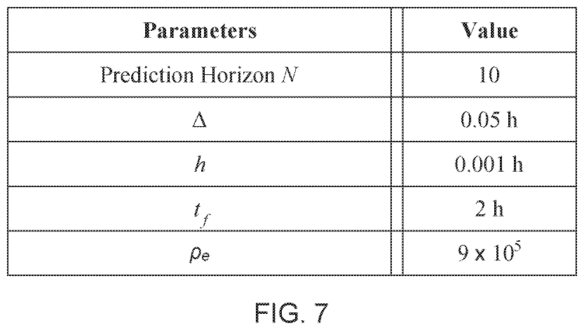

The MPC method illustrated in FIG. 4 and the EMPC method illustrated in FIG. 6 can be implemented in the control system 550 associated with the system 500. These cases were simulated in software as now discussed. Throughout the simulation for both the MPC and EMPC methods, the number of control-volume cells Nc chosen to model the system is 6. This number of cells generates 40 differential and algebraic process states \tilde{x}. The permeate inlet temperature, feed inlet flow rate and permeate inlet flow rate are fixed as 20° C., 0.1667 ms⁻¹ and 0.1111 ms⁻¹, respectively. Because of the physical constraints on the solar thermal energy, the inlet feed temperature u(t) is constrained as follows −25° C.≤u−uₛₛ≤15° C. The remaining model parameters, which are used in this simulation, can be found in [7]. The built-in function in Matlab called ode15s was used with an integration step size of h=10⁻³ to simulate the process of equation (1). This numerical integration method requires consistent initial conditions in order to successfully start the integration. Some methods for the initialization of DAE systems have been reported in the literature. In this embodiment, the consistent initial conditions are computed by solving the system's equations. The optimization problem of equations (13a) to (13f) and of equations (14a) to (14h) were solved by the Matlab's built-in function f_{mincon}. The parameters of the MPC and EMPC used in the simulations are presented in Table II in FIG. 7.

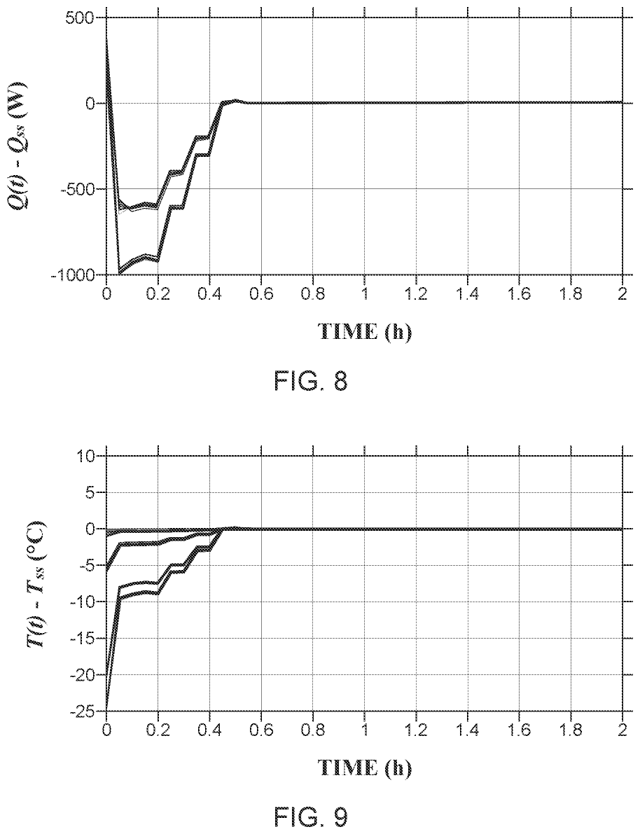

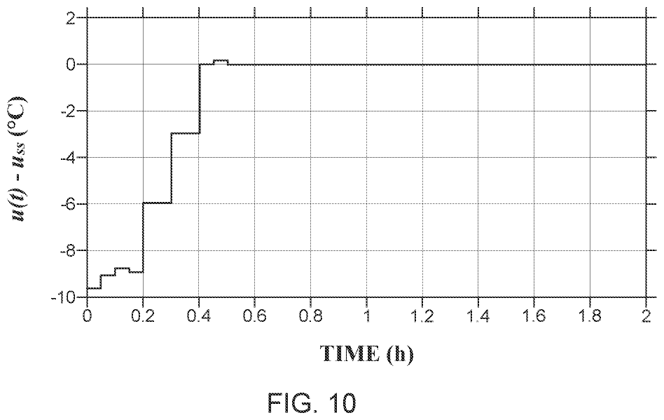

For these simulations, the DCMD process of equation (1) was used when operated by the proposed MPC scheme illustrated in FIG. 4. The DCMD process was operated around an optimal asymptotic stable steady-state that corresponds to an inlet feed temperature uₛₛ=50° C., which is based on previous experience. The 40 steady-state values (Xₛₛ∈R⁴⁰) are obtained via solving the nonlinear algebraic equations given by equation (13b). The control objective of the MPC scheme is to drive the process states into the steady-state as fast as the rate defined by matrix W while using the appropriate amount of energy defined by the matrix R over an operating period of length t_{f}=2h. FIGS. 8 and 9 show the close-loop trajectory for each process state \tilde{x} (which can be either a temperature or a heat flow rate) and FIG. 10 illustrates the manipulated input profile u(t) under the MPC formulation of equations (13a) to (13f). The process states \tilde{x} were represented into two plots (FIGS. 8 and 9) because the heat transfer rates and temperatures have different order of magnitude. From FIGS. 8 and 9, both the differential and algebraic closed-loop states were successfully driven into the steady-state point under the MPC scheme of equations (13a) to (13f). Specifically, all process states \tilde{x} were able to reach the steady-state point after approximately 10 sampling periods (i.e., at t=0.5h). To drive the closed-loop state into the steady-state, the manipulated input u−uₛₛ increased in FIG. 10 gradually, until it reached its steady-state point, which is u−uₛₛ=0° C. In addition, FIG. 10 shows that the smoothness constraint (see equation (13f)) on any consecutive control action was satisfied during the operating period.

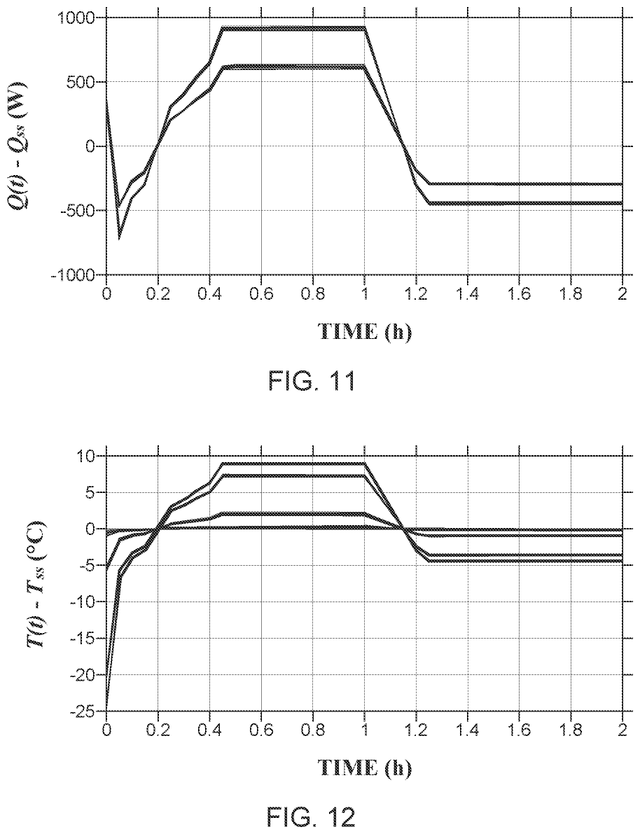

The EMPC simulation results are now discussed. To demonstrate the effectiveness of the time-varying operation that the proposed EMPC method of FIG. 6 dictates, the DCMD module described by equation (1) was operated under the EMPC control strategy for a two-hour operating period. The DCMD process of equation (1) is initiated from the same point that the process is initiated under the MPC method of equations (13a) to (13f). The objective of the EMPC method is to maximize the distilled water flux using the following stage cost:

$${J}_{e} = ζ [ λ exp ( 23.2 - \frac{227.02}{3816.4 {T}_{m f}} ) - exp ( 23.2 - \frac{227.02}{3816.4 {T}_{m p}} ) ] , \qquad ( 15 )$$

where ζ and λ refer to the membrane mass transfer coefficient and the mole fraction of NaCl in the feed stream, respectively. The temperature at the membrane-feed interface and the temperature at the membrane-permeate interface are denoted by T_{mf} and Tₘₚ. Both temperatures T_{mf} and Tₘₚ are process states of the DCMD system of equation (1). The tuning parameter w of equation (14a) is chosen to be 0.7 throughout the simulation. FIGS. 11 and 12 illustrate the heat transfer rate and the temperature states trajectories under the EMPC method of the DCMD process of equation (1). More specifically, FIGS. 11 and 12 show the closed-loop state trajectory for the heat and temperature states while FIG. 13 shows the manipulated input profile u(t) under the EMPC scheme. From these figures, one can observe that the closed-loop states took about 9 sampling periods (i.e., t=0.45h) to reach a point where ΔT(t)=25° C., and then they remain there until the mid of the operating period (t=1h). Subsequently, due to the constraint of equation (14h), the closed-loop states decreased gradually, to reach a point in the state-space where ΔT(t)=17° C. Moreover, FIG. 13 indicates that the manipulated input trajectory u(t) satisfied both the boundedness constraint of equation (14c) and the smoothness constraint of equation (14g).

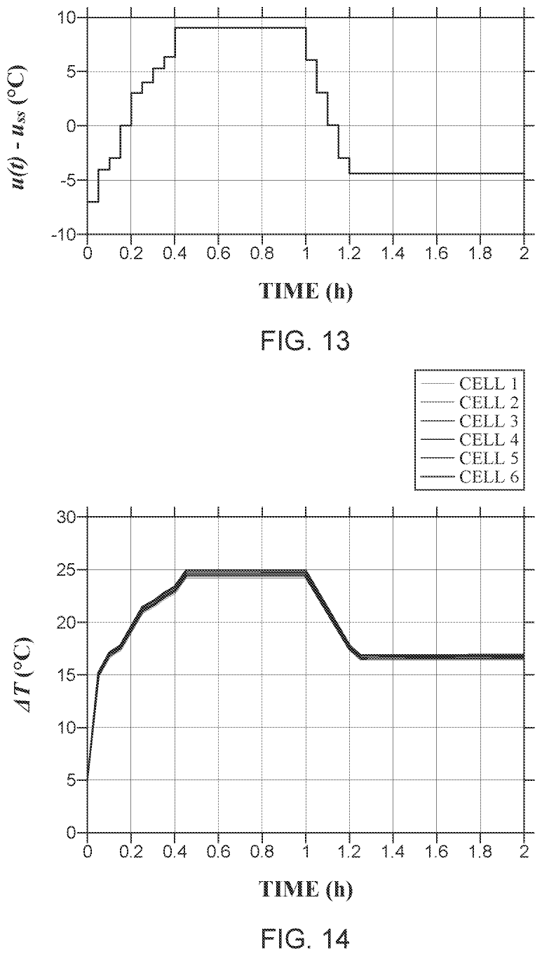

FIG. 14 shows the ΔT(t) value along the membrane over the full operating period (i.e., at all the cells along the membrane). The EMPC method of equations (14a) to (14h) is able to keep the ΔT(t) value constant along the membrane during the first half of the operating period. Then, the ΔT(t) decreased gradually to reach the second required value of ΔT(t)=17° C. and remained there until the end of the operating period.

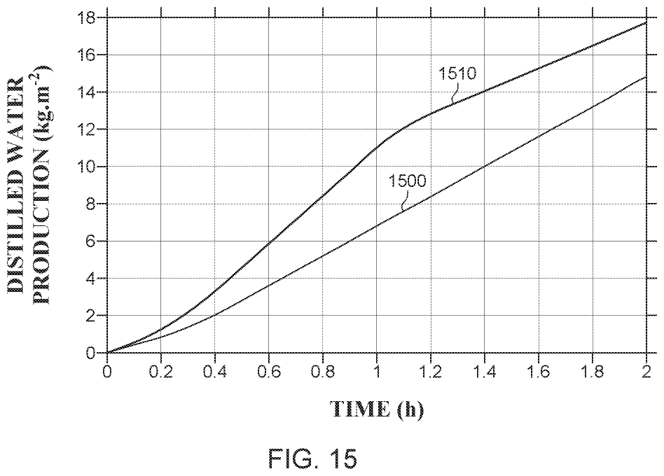

Next, the performance of the system 500 when controlled with the MPC method of FIG. 4 and when controlled with the EMPC method of FIG. 6 is compared. The distilled water production is computed under both control designs. The distilled water production is the integration of the distilled water flux of equations (14a) to (14h) over the two-hour operating period. Based on the obtained manipulated input profile and the closed loop trajectories under both schemes (i.e., FIGS. 8-9 and 11-13), the distilled water production is calculated. FIG. 15 shows the distilled water production 1500 for the MPC method and 1510 for the EMPC method. From this figure, it can be seen that the DCMD process produced more fresh water under the EMPC method than the one under the MPC method. Specifically, the total distilled water production under the EMPC method increased by approximately 22.1% with respect to the one produced by the MPC method.

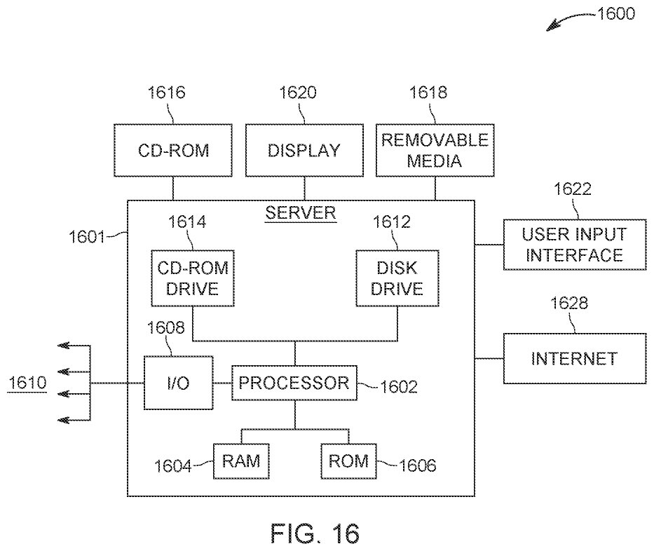

The above-discussed procedures and methods may be implemented in a computing device (control system 550) as illustrated in FIG. 16. Hardware, firmware, software or a combination thereof may be used to perform the various steps and operations described herein. Computing device 1600 of FIG. 16 is an exemplary computing structure that may be used in connection with such a system.

Computing device 1600 suitable for performing the activities described in the exemplary embodiments may include a server 1601. Such a server 1601 may include a central processor (CPU) 1602 coupled to a random access memory (RAM) 1604 and to a read-only memory (ROM) 1606. ROM 1606 may also be other types of storage media to store programs, such as programmable ROM (PROM), erasable PROM (EPROM), etc. Processor 1602 may communicate with other internal and external components through input/output (I/O) circuitry 1608 and bussing 1610 to provide control signals and the like. Processor 1602 carries out a variety of functions as are known in the art, as dictated by software and/or firmware instructions.

Server 1601 may also include one or more data storage devices, including hard drives 1612, CD-ROM drives 1614 and other hardware capable of reading and/or storing information, such as DVD, etc. In one embodiment, software for carrying out the above-discussed steps may be stored and distributed on a CD-ROM or DVD 1616, a USB storage device 1618 or other form of media capable of portably storing information. These storage media may be inserted into, and read by, devices such as CD-ROM drive 1614, disk drive 1612, etc. Server 1601 may be coupled to a display 1620, which may be any type of known display or presentation screen, such as LCD, plasma display, cathode ray tube (CRT), etc. A user input interface 1622 is provided, including one or more user interface mechanisms such as a mouse, keyboard, microphone, touchpad, touch screen, voice-recognition system, etc.

Server 1601 may be coupled to other devices, such as pumps, pressure sensors, temperature sensors, etc. The server may be part of a larger network configuration as in a global area network (GAN) such as the Internet 1628, which allows ultimate connection to various landline and/or mobile computing devices.

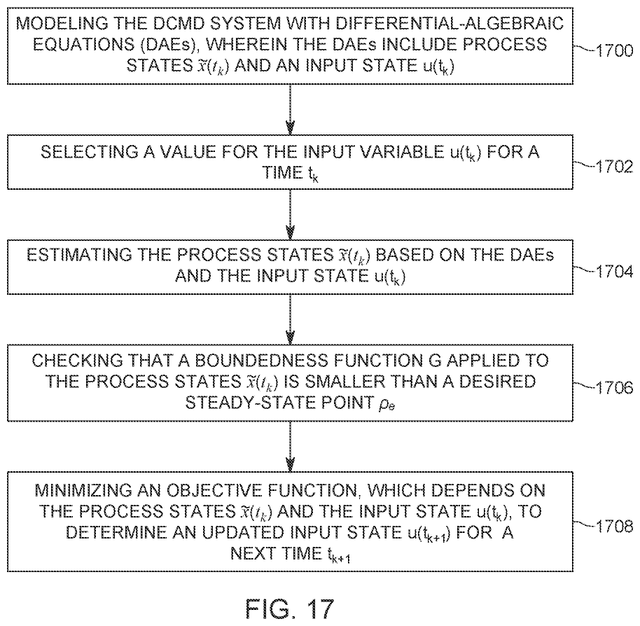

The control system 550 may be configured to implement the following method for controlling the DCMD system 500, which is discussed with regard to FIG. 17. The method includes a step 1700 of modeling the DCMD system with differential-algebraic equations (DAEs), where the DAEs include process states \tilde{x}(tₖ) and an input state u(tₖ), a step 1702 of selecting a value for the input variable u(tₖ) for a time tₖ, a step 1704 of estimating the process states \tilde{x}(tₖ) based on the DAEs and the input state u(tₖ), a step 1706 of checking that a boundedness function G applied to the process states \tilde{x}(tₖ) is smaller than a desired steady-state point ρₑ, and a step 1708 of minimizing an objective function, which depends on the process states \tilde{x}(tₖ) and the input state u(tₖ), to determine an updated input state u(tₖ₊₁) for a next time tₖ₊₁. The process states \tilde{x}(tₖ) include temperatures and heat flow rates.

In one application, the input state is a feed input temperature. In another application, the input state is a feed inlet mass flow rate. The method may further include a step of verifying that the input state u(tₖ) belongs to a convex set over a prediction horizon, and/or verifying that the input state u(tₖ) at the time tₖ is not larger than a previous input state u(tₖ₋₁) by more than a given threshold value. The step of estimating may further include applying a transit input states matrix B to the input state to obtain a first term; applying a function F to the input states to obtain a second term; and adding the first and second terms and making them equal to a matrix E applied to a time derivative of the input states to obtain the DAEs.

In one application, the objective function is defined as a sum of a first term (A), which includes a product of (1) a transpose of the input states, (2) a weight matrix W, (3) the input states, and a second term (B), which includes (4) a transpose of the input state, (5) a weight matrix R, and (3) the input state.

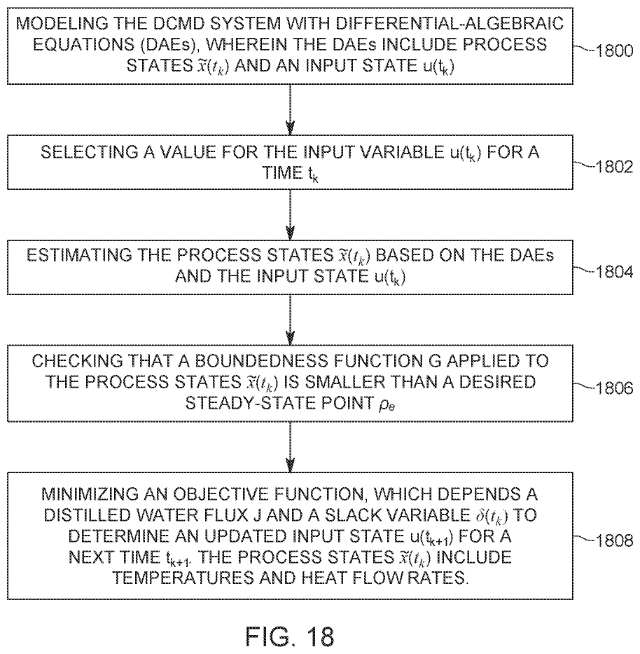

According to another embodiment, the DCMD system 500 may be controlled with a different method. This method, as illustrated in FIG. 18, includes a step 1800 of modeling the DCMD system with differential-algebraic equations (DAEs), where the DAEs include process states \tilde{x}(tₖ) and an input state u(tₖ), a step 1802 of selecting a value for the input variable u(tₖ) for a time tₖ, a step 1804 of estimating the process states \tilde{x}(tₖ) based on the DAEs and the input state u(tₖ), a step 1806 of checking that a boundedness function G applied to the process states \tilde{x}(tₖ) is smaller than a desired steady-state point ρₑ, and a step 1808 of maximizing or minimizing an objective function, which depends a distilled water flux J and a slack variable δ(tₖ), to determine an updated input state u(tₖ₊₁) for a next time tₖ₊₁. The process states \tilde{x}(tₖ) include temperatures and heat flow rates.

In one application, the input state is a feed input temperature. In another application, the input state is a feed inlet mass flow rate. The distilled water flux J depends on the process states and the input state. The slack variable δ(tₖ) is added to an optimal temperature to define a temperature difference between a feed side and a permeate side of a membrane that is used by the DCMD system. In one embodiment, the optimal temperature has a first set value for a first period and a second set value for a second time period.

In one embodiment, the method may further include a step of verifying that the input state u(tₖ) belongs to a convex set over a prediction horizon, and/or a step of verifying that the input state u(tₖ) at the time tₖ is not larger than a previous input state u(tₖ₋₁) by more than a given threshold value. The step of estimating may further include applying a transit input states matrix B to the input state to obtain a first term; applying a function F to the input states to obtain a second term; and adding the first and second terms and making them equal to a matrix E applied to a time derivative of the input states to obtain the DAEs. In one application, the objective function is defined as a sum of the distilled water flux J and square of an absolute value of the slack variable δ(tₖ).

The disclosed embodiments provide methods for controlling a DCMD system for generating distilled water. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

[1] A. M. Karam and T. M. Laleg-Kirati. Real time optimization of solar powered direct contact membrane distillation based on multivariable extremum seeking. IEEE Conference on Control Applications, 1618-1623, 2015.
[2] F. Eleiwi and T. M. Laleg-Kirati. Observer-based perturbation ex-tremum seeking control with input constraints for Direct-Contact Mem-brane Distillation process. International Journal of Control, 91: 1363-1375, 2018.
[3] D. J. Gila, L. Roca, A. Ruiz-Aguirre, G. Zaragoza, and M. Berenguel. Optimal operation of a solar membrane distillation pilot plant via non-linear model predictive control. Computers and Chemical Engineering. 109: 151-165, 2018.
[4] C. O. Ayala, L. Roca, J. L. Guzman, J. E. Normey-Rico, M. Berenguel, and L. J. Yebra. Local model predictive controller in a solar desalination plant collector field. Renewable Energy, 36: 3001-3012, 2011.
[5] Y. Wang, T. Alamo, V. Puig, and G. Cembrano. Periodic economic model predictive control with nonlinear-constraint relaxation for water distribution networks. IEEE Conference on Control Applications, 1167-1172, 2016.
[6] A. M. Karam and T. M. Laleg-Kirati. Electrical equivalent thermal network for direct contact membrane distillation modeling and analysis. Journal of Process Control, 47: 87-97, 2016.
[7] A. M. Karam, A. S. Alsaadib, N. Ghaffourb, and T. M. Laleg-Kirati. Analysis of direct contact membrane distillation based on a lumped-parameter dynamic predictive model. Desalination, 402: 50-61, 2017.

1. A method for controlling a direct contact membrane distillation (DCMD) system, the method comprising:
modeling the DCMD system with differential-algebraic equations (DAEs), wherein the DAEs include process states \tilde{x}(tₖ) and an input state u(tₖ);
selecting a value for the input variable u(tₖ) for a time tₖ;
estimating the process states \tilde{x}(tₖ) based on the DAEs and the input state u(tₖ);
checking that a boundedness function G applied to the process states \tilde{x}(tₖ) is smaller than a desired steady-state point ρₑ; and
minimizing an objective function, which depends on the process states \tilde{x}(tₖ) and the input state u(tₖ), to determine an updated input state u(tₖ₊₁) for a next time tₖ₊₁,
wherein the process states \tilde{x}(tₖ) include temperatures and heat flow rates.

2. The method of claim 1, wherein the input state is a feed input temperature.

3. The method of claim 1, wherein the input state is a feed inlet mass flow rate.

4. The method of claim 1, further comprising:
verifying that the input state u(tₖ) belongs to a convex set over a prediction horizon.

5. The method of claim 4, further comprising:
verifying that the input state u(tₖ) at the time tₖ is not larger, as an absolute value, than a previous input state u(tₖ₋₁), by more than a given threshold value.

6. The method of claim 1, wherein the step of estimating further comprises:
applying a transit input states matrix B to the input state to obtain a first term;
applying a function F to the input states to obtain a second term; and
adding the first and second terms and making them equal to a matrix E applied to a time derivative of the input states to obtain the DAEs.

7. The method of claim 1, wherein the objective function is defined as a sum of a first term (A), which includes a product of (1) a transpose of the input states, (2) a weight matrix W, (3) the input states, and a second term (B), which includes (4) a transpose of the input state, (5) a weight matrix R, and (3) the input state.

8. A method for controlling a direct contact membrane distillation (DCMD) system, the method comprising:
modeling the DCMD system with differential-algebraic equations (DAEs), wherein the DAEs include process states \tilde{x}(tₖ) and an input state u(tₖ);
selecting a value for the input variable u(tₖ) for a time tₖ;
estimating the process states \tilde{x}(tₖ) based on the DAEs and the input state u(tₖ);
checking that a boundedness function G applied to the process states \tilde{x}(tₖ) is smaller than a desired steady-state point ρₑ; and
minimizing an objective function, which depends on a distilled water flux J and a slack variable δ(tₖ), to determine an updated input state u(tₖ₊₁) for a next time tₖ₊₁,
wherein the process states \tilde{x}(tₖ) include temperatures and heat flow rates.

9. The method of claim 8, wherein the input state is a feed input temperature.

10. The method of claim 8, wherein the input state is a feed inlet mass flow rate.

11. The method of claim 8, wherein the distilled water flux J depends on the process states and the input state.

12. The method of claim 8, wherein the slack variable δ(tₖ) is added to an optimal temperature to define a temperature difference between a feed side and a permeate side of a membrane that is used by the DCMD system.

13. The method of claim 12, wherein the optimal temperature has a first set value for a first period and a second set value for a second time period.

14. The method of claim 8, further comprising:
verifying that the input state u(tₖ) belongs to a convex set over a prediction horizon.

15. The method of claim 14, further comprising:
verifying that the input state u(tₖ) at the time tₖ is not larger than a previous input state u(tₖ₋₁) by more than a given threshold value.

16. The method of claim 8, wherein the step of estimating further comprises:
applying a transit input states matrix B to the input state to obtain a first term;
applying a function F to the input states to obtain a second term; and
adding the first and second terms and making them equal to a matrix E applied to a time derivative of the input states to obtain the DAEs.

17. The method of claim 8, wherein the objective function is defined as a sum of the distilled water flux J and a square of an absolute value of the slack variable δ(tₖ).

18. A direct contact membrane distillation (DCMD) system comprising:
a distillation membrane;
a feed part in contact with the distillation membrane, the feed part configured to receive a feed;
a permeate part in contact with the distillation membrane, the permeate part configured to receive a permeate; and
a controller configured to control a flow of the feed,
wherein the controller is configured to,
model the DCMD system with differential-algebraic equations (DAEs), wherein the DAEs include process states \tilde{x}(tₖ) and an input state u(tₖ);
select a value for the input variable u(tₖ) for a time tₖ;
estimate the process states \tilde{x}(tₖ) based on the DAEs and the input state u(tₖ);
check that a boundedness function G applied to the process states \tilde{x}(tₖ) is smaller than a desired steady-state point ρₑ; and
minimize an objective function to determine an updated input state u(tₖ₊₁) for a next time tₖ₊₁,
wherein the objective function depends on a distilled water flux J and a slack variable δ(tₖ) or the objective function depends on the process states \tilde{x}(tₖ) and the input state u(tₖ).

19. The DCMD system of claim 18, wherein the process states \tilde{x}(tₖ) include temperatures and heat flow rates.

20. The DCMD system of claim 19, wherein the input state is a feed input temperature or a feed inlet mass flow rate.
